(19) United States
(12) Patent Application Publication
(10) Pub. No.: US 2007/0050785 A1
(43) Pub. Date: Mar. 1, 2007

(54) Clamper for recording/reproducing apparatus and recording/reproducing apparatus comprising the same

(75) Inventor: Tetsuro Osaki, Echizen-city (JP)

Correspondence Address: JORDAN AND HAMBURG LLP, 122 EAST 42ND STREET, SUITE 4000, NEW YORK, NY, 10168, US

(73) Assignee: ORION ELECTRIC Co., Ltd., Echizen-city (JP)

(21) Appl. No.: 11/508,721

(22) Filed: Aug. 23, 2006

(30) Foreign Application Priority Data
Aug. 31, 2005 (JP) 2005-251455

(51) Int. Cl. G11B 17/04

(52) U.S. Cl. 720/604

(57) ABSTRACT

The present invention provides a damper comprising a circular dish-shaped bottom surface portion for pressing an optical disk, an annular magnet member provided at a central portion of an upper surface of the bottom surface portion, a plurality of base pieces spaced apart from each other and disposed around the magnet member, a plurality of elastic arm pieces bent and extending in the same direction from the respective base pieces, and substantially horizontal stopper fins provided at tip portions of the respective arm pieces and protruding in a radially outward direction of the bottom surface portion. A stroke (vertical movement) of the damper in association with a loading/unloading action of a tray, which allows the optical disk to be placed, is secured by a helical movement action along the arm pieces, thereby reducing a thickness of the damper for sandwiching and holding the optical disk. It is also possible to reduce thicknesses of a recording/reproducing apparatus comprising the damper and an electronic apparatus comprising the recording/reproducing apparatus.

### CROSS REFERENCE TO RELATED APPLICATION

The disclosure of Japanese Patent Applications enumerated below including specification, drawings and claims is incorporated herein by reference in its entirety:

No. 2005-251455 filed Aug. 31, 2005.

### BACKGROUND OF THE INVENTION

1. Field of the Invention

The present invention relates to a damper for a recording/reproducing apparatus which sandwiches and holds a storage medium inserted into the apparatus with a turntable, and a recording/reproducing apparatus comprising the clamper. More particularly, the present invention relates to a structure of a damper which contributes to, for example, the reduction of thickness of a recording/reproducing apparatus. Note that the recording/reproducing apparatus as used herein refers to a recording apparatus which records a recording medium, a reproducing apparatus which reproduces a recording medium, or a recording/reproducing apparatus which records and reproduces a recording medium.

2. Description of the Related Art

There is a recording/reproducing apparatus which records or reproduces an optical disk, such as a DVD, a CD or the like, which is a storage medium for recording information, or a storage medium on which information is previously recorded. The recording/reproducing apparatus is, for example, composed of: a tray which is freely conveyed into or out of an outer casing so as to load or unload the optical disk; a turntable comprising a magnetic material which holds up and rotates the optical disk loaded in the outer casing; an optical pickup unit which emits laser light onto a recording surface of the optical disk held up by the turntable so as to record information onto the optical disk or reproduce information previously recorded on the disk; and the like. The recording/reproducing apparatus is also provided with a damper which includes a magnet member and can be freely vertically moved and freely rotated, and is located at an upper position of the outer casing, facing the turntable. The optical disk loaded in the outer casing is sandwiched and held by a magnetic force generated between the turntable and the clamper.

The operation of sandwiching and holding the optical disk will be described in detail. The optical disk which is placed on the tray outside the outer casing, is loaded along with the tray into the outer casing. When the tray reaches a predetermined position in the outer casing, the turntable which is previously located at a low position starts to be lifted, so that the optical disk is transferred from the tray to the turntable. Thereafter, the damper provided at the upper portion of the outer casing presses the optical disk from the turntable facing position. The turntable starts rotating while being thus pressed by the clamper.

In this case, when the turntable approaches a lower portion of the clamper, the magnet member of the damper and the magnetic material on the turntable magnetically attract each other, so that the damper is detachably tightly attached to the turntable via the optical disk, pressing the optical disk against the turntable to avoid displacement of the optical disk.

When the optical disk is unloaded from the outer casing, the turntable which sandwiches and holds the optical disk with the damper is lowered so that the damper is released from the turntable, and thereafter, the optical disk on the turntable is transferred onto the tray, and the tray is unloaded to the outside of the outer casing.

### SUMMARY OF THE INVENTION

Regarding electronic apparatuses comprising such a recording/reproducing apparatus, it is desired to reduce a thickness of the recording/reproducing apparatus as much as possible so as to, for example, reduce a size of the electronic apparatus. Also, there is a demand for the reduction of the number of parts as much as possible in view of simplification of assembly, reduction of cost, and the like. In addition, there is a demand for a low noise property during an operation of the recording/reproducing apparatus so as to, for example, improve quality.

In this case, also regarding the clamper, it is necessary to provide a structure which reduce the number of parts and contributes to the reduction of thickness of a recording/reproducing apparatus, and suppress discomfortable strike sound.

The present applicant has proposed in applications already filed and the like (e.g., Japanese Patent Laid-Open Publication No. 2005-18951) a recording/reproducing apparatus comprising a damper 100 illustrated in FIG. 9 (exploded perspective view) and FIG. 10 (cross-sectional view indicating an attached state).

The damper 100 already proposed has a circular dish-shaped damper main body 101 which is formed of a resin and serves as a disk pressing portion. An annular magnet member 103 is provided inside a cylindrical guide 102 erected and provided at a center portion of an upper surface of the damper main body 101. The magnet member 103 is fitted and fixed between the guide 102 and a cylindrical protrusion 104 which is concentrically provided inside the guide 102.

Further, for example, three nail portions 105 are provided and protruded at an upper end portion of the guide 102. Each nail portion 105 has an outer nail portion 105a which is protruded outward and inclined downward.

On the other hand, an opening portion 201 for attaching the damper is provided in a support member 200 which is a horizontal metal plate (steel plate, etc.), such as a top plate of the outer casing (main body frame) provided above the turntable of the optical disk drive.

The damper 100 is inserted and pushed up into the opening portion 201 from below the support member 200. By pushing up, each nail portion 105 at the upper end portion of the guide 102 strikes a circular periphery of the opening portion 201, is bent inward due to the elasticity (spring property) thereof, passes through the opening portion 201, protrudes above the opening portion 201, and expands outward to return to the original state. As a result, a lower surface of each nail portion 105 is engaged with an upper surface of the circular periphery of the opening portion 201 so that the nail portion 105 is prevented from being extracted. As a result, the damper 100 attached to the opening portion 201 is supported in a manner which allows the damper 100 to freely rotate and vertically move with respect to the support member 200.

When the turntable is located at a standby position away and below the damper 100, an attraction force acts between the magnet member 103 provided in the damper 100 and the support member 200 formed of the magnetic material, so that the whole damper 100 is levitated upward. Note that, for example, in the case of a recording/reproducing apparatus comprising a tray, the turntable is down at the standby position when the tray is unloaded out of the recording/reproducing apparatus or the tray is partway through the loading or unloading action.

Next, when an optical disk is loaded by the tray from the outside of the recording/reproducing apparatus into between the turntable and the damper 100, the turntable is lifted to approach the damper 100 as described above, a magnetic force acts between the magnetic material on the turntable and the magnet member 103 provided in the clamper, and the magnetic force becomes larger than an attraction force acting between the support member 200 and the magnet member 103, so that the damper 100 is attracted to the turntable to sandwich and hold the optical disk. In this state, the optical disk is recorded or read while the turntable is driven and rotated.

In this structure, an additional dedicated magnet or magnetic material for pulling up the damper 100 when the turntable is down at the standby position, is not required, thereby increasing the degree of freedom of design. A space for providing a magnet or a magnetic material can be used as a space for moving the damper 100, so that a long stroke of the damper 100 is obtained. Therefore, when an optical disk is loaded, the damper 100 can be pulled up and retracted to avoid hindering loading, thereby making it possible to reduce a thickness of the recording/reproducing apparatus. In addition, since an additional magnet or the like for retracting the damper 100 is not required, the structure can be simplified and the number of parts can be reduced, and therefore, manufacturing cost can be reduced.

In the optical disk clamping mechanism of the recording/reproducing apparatus of FIGS. 9 and 10, the damper 100 has a vertically moving stroke and has each nail portion 105 bent downward as a hook, and the nail portions 105 are hooked to the support member 200 (a top plate, etc.) so that the damper 100 is substantially vertically suspended and supported.

In the case of this structure, in order to reliably support the damper 100 by securing a sufficient degree of hooking of each nail portion 105 with respect to the support member 200, the nail portion 105 needs to be elongated upward to some extent, resulting in an increase in the stroke of the damper 100, so that the damper 100 cannot be sufficiently thinned. Thus, the further reduction of thickness of the recording/reproducing apparatus is hindered.

Also, when each nail portion 105 is elongated, the stroke is also elongated, so that the vertical movement distance of the damper 100 becomes longer. In this case, when an optical disk loaded into the recording/reproducing apparatus is sandwiched, each nail portion 105 of the damper 100 which is lowered by the attraction force between the damper 100 and the magnetic material of the turntable strikes the metal support member 200, thereby generating discomfortable strike sound. Therefore, a sufficient low noise property is not obtained, so that it is difficult to further improve the quality of the recording/reproducing apparatus, for example.

An object of the present invention is to provide a thinner structure of a damper included in a recording/reproducing apparatus of this type, thereby making it possible to further reduce a thickness of the recording/reproducing apparatus due to the thinned clamper. Another object of the present invention is to further reduce a thickness of an electronic apparatus comprising the recording/reproducing apparatus. In addition to these objects, still another object of the present invention is to reduce discomfortable strike sound caused by vertical movement of the damper to improve the low noise property, and achieve the thin structure of the damper without increasing the number of parts.

To achieve the objects, a damper according to a first aspect of the present invention is provided for a recording/reproducing apparatus, the damper being fitted in an attachment opening portion provided in a horizontal support plate in a manner which allows the damper to freely rotate and freely vertically move. The damper comprises a circular dish-shaped bottom surface portion for pressing a disk-shaped storage medium, an annular magnet member provided at a central portion of an upper surface of the bottom surface portion, a plurality of base pieces spaced apart from each other and disposed around the magnet member, elastic arm pieces bent and extending in the same direction from the respective base pieces and provided at a distance from the bottom surface portion, and substantially horizontal stopper fins provided at tip portions of the respective arm pieces and protruding in a radially outward direction of the bottom surface portion.

According the damper of the first aspect of the present invention, unlike a structure in which a plurality of nail portions (hooks) are provided and are substantially vertically hooked to a support plate, the arm pieces which are bent and extend in the same direction (clockwise or anticlockwise) from the respective base pieces on the bottom surface portion forming a disk pressing portion and have a spring property, are provided, and the substantially horizontal stopper fins extruding in the radially outward direction of the bottom surface portion are provided at the tip portions of the respective arm pieces. Each arm piece is loosely fitted into the attachment opening portion of the support plate from the bottom, so that a lower surface of each stopper fin contacts an upper surface of a circular periphery of the attachment opening portion of the support plate to be engaged with the support plate, so that the damper is supported in a manner which allows the damper to freely rotate and freely vertically move.

In this case, each arm piece has a shape that a gap between the arm piece and the bottom surface portion increases from a portion thereof closer to the base piece toward a tip portion thereof. A stroke (vertical movement) of the damper in association with a disk loading or unloading action is secured by a helical movement action along the arm pieces, thereby making it possible to reduce a thickness as compared to conventional clampers. In addition, the stopper fin is used to secure a sufficient degree of hooking with respect to the support plate so that the damper can be reliably engaged with the support plate.

Therefore, according to the damper of the first aspect of the present invention, it is possible to provide a thinner structure of a recording/reproducing apparatus comprising such a clamper. As a result, it is possible to further reduce a thickness of an electronic apparatus comprising such a recording/reproducing apparatus. Also, with the above-described helical movement action, the occurrence of discomfort strike sound due to the vertical movement of the damper can be reduced, thereby making it possible to improve a low noise property.

A damper according to a second aspect of the present invention is provided for a recording/reproducing apparatus, the damper being fitted in an attachment opening portion provided in a horizontal support plate in a manner which allows the damper to freely rotate and freely vertically move. The damper comprises a circular dish-shaped bottom surface portion for pressing a disk-shaped storage medium, an annular magnet member provided at a central portion of an upper surface of the bottom surface portion, a plurality of base pieces spaced apart from each other and disposed around the magnet member, elastic arm pieces bent and extending in the same direction from the respective base pieces and provided at a distance from the bottom surface portion, and substantially horizontal stopper fins provided at tip portions of the respective arm pieces and protruding in a radially outward direction of the bottom surface portion. The bottom surface portion, the base pieces, the arm pieces and the stopper fins constituting the damper are integrally formed.

Therefore, according to the damper of the second aspect of the present invention, the bottom surface portion, the base pieces, the arm pieces and the stopper fins constituting the damper are integrally formed, thereby making it possible to achieve an effect similar to the first aspect of the present invention while simplifying assembly and reducing cost without increasing the number of parts.

A damper according to a third aspect of the present invention is provided for a recording/reproducing apparatus, the damper being fitted in an attachment opening portion provided in a horizontal support plate in a manner which allows the damper to freely rotate and freely vertically move. The damper comprises a circular dish-shaped bottom surface portion for pressing a disk-shaped storage medium, an annular magnet member provided at a central portion of an upper surface of the bottom surface portion, a plurality of base pieces spaced apart from each other and disposed around the magnet member, elastic arm pieces bent and extending in the same direction from the respective base pieces and provided at a distance from the bottom surface portion, and substantially horizontal stopper fins provided at tip portions of the respective arm pieces and protruding in a radially outward direction of the bottom surface portion. An upper surface of the stopper fin is inclined downward.

Therefore, according to the third aspect of the present invention, in the damper of the first aspect of the present invention, the upper surface of the stopper fin is inclined downward. Therefore, it is easy to loosely fit the damper into the attachment opening portion of the support plate, resulting in further ease of assembly.

A damper according to a fourth aspect of the present invention is provided for a recording/reproducing apparatus, the damper being fitted in an attachment opening portion provided in a horizontal support plate in a manner which allows the damper to freely rotate and freely vertically move. The damper comprises a circular dish-shaped bottom surface portion for pressing a disk-shaped storage medium, an annular magnet member provided at a central portion of an upper surface of the bottom surface portion, a plurality of base pieces spaced apart from each other and disposed around the magnet member, elastic arm pieces bent and extending in the same direction from the respective base pieces and provided at a distance from the bottom surface portion, and substantially horizontal stopper fins provided at tip portions of the respective arm pieces and protruding in a radially outward direction of the bottom surface portion. The bottom surface portion, the base pieces, the arm pieces and the stopper fins constituting the damper are integrally formed, and an upper surface of the stopper fin is inclined downward.

Therefore, according to the fourth aspect of the present invention, in the damper of the second aspect of the present invention, the upper surface of the stopper fin is inclined downward. Therefore, it is easy to loosely fit the damper into the attachment opening portion of the support plate, resulting in further ease of assembly.

A damper according to a fifth aspect of the present invention is the damper of any one of the first to fourth aspects of the present invention in which a stopper protrusion protruding in a radially inward direction of the bottom surface portion is provided at least at a portion of the arm pieces, and a lower surface of the stopper protrusion contacts an upper surface of the magnet member provided at the central portion of the upper surface of the bottom surface portion.

Therefore, according to the damper of the fifth aspect of the present invention, a stopper protrusion protruding in a radially inward direction of the bottom surface portion is provided at least at a portion of the arm pieces, and a lower surface of the stopper protrusion contacts an upper surface of the magnet member provided at the central portion of the upper surface of the bottom surface portion, thereby making it possible to reliably hold the magnet member at the central portion of the upper surface of the bottom surface portion even in the case of high-speed rotation and the like.

A damper according to a sixth aspect of the present invention is the damper of the fifth of the present invention in which an upper surface of the stopper protrusion is inclined downward.

In this case, since the upper surface of the stopper protrusion is inclined downward, the magnet member can be easily fitted into the clamper.

A recording/reproducing apparatus according to a seventh aspect of the present invention comprises a horizontal support plate made of a metal and having an attachment opening portion, wherein the horizontal support plate is provided on an upper surface of an outer casing, the damper according to any one of the first to sixth aspects of the present invention, in which the damper is made of a resin and the damper is fitted into the attachment opening portion of the support plate in a manner which allows the damper to freely rotate and freely vertically move, a magnet member provided in the clamper, a turntable including a magnetic material for holding up a storage medium inserted into the outer casing from a position where the magnetic material faces the damper so that the storage medium can be rotated, and a pickup unit for irradiating a recording surface of the storage medium with laser light to read or write information. The turntable can be moved in a height direction. When the turntable is at a high position, the turntable and the damper at an opposed position sandwich and hold the storage medium due to a magnetic force, and when the turntable is at a low position, a magnetic force acts between the damper at the opposed position and the support plate to pull up the damper due to an attraction force.

Therefore, according to the recording/reproducing apparatus of the seventh aspect of the present invention, the support plate is made of a metal and is provided at an upper portion of the recording/reproducing apparatus, and the damper made of a resin is provided on the support plate. Thereby, in addition to an effect similar to that of the clamper of each of the above-described aspects of the present invention, it is possible to provide a thin recording/reproducing apparatus in which strike sound due to the vertical movement of the damper can be further reduced, so that quality is improved.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a perspective view illustrating an outer appearance shape of a recording/reproducing apparatus of an embodiment of the present invention when a tray is housed.

FIG. 2 is a perspective view illustrating an outer appearance shape of the recording/reproducing apparatus of the embodiment of the present invention when the tray is unloaded.

FIG. 3 is a perspective view illustrating an outer appearance shape of a damper of the embodiment of the present invention singly.

FIG. 4 is a plan view illustrating the damper of the embodiment of the present invention singly.

FIG. 5 is a front view illustrating the damper of the embodiment of the present invention singly.

FIG. 6A is a partially enlarged plan view illustrating a vicinity of an arm piece of the damper of the embodiment of the present invention.

FIG. 6B is a partially enlarged front view illustrating a vicinity of an arm piece of the damper of the embodiment of the present invention.

FIG. 7 is a cross-sectional side view illustrating a state of the damper of the embodiment of the present invention before attachment.

FIG. 8 is a cross-sectional side view illustrating a state of the damper of the embodiment of the present invention after attachment.

FIG. 9 is an exploded perspective view illustrating a state of a conventional damper before attachment.

FIG. 10 is a cross-sectional side view illustrating a state of the conventional damper after attachment.

### DETAILED DESCRIPTION OF THE PREFERRED EMBODIMENT

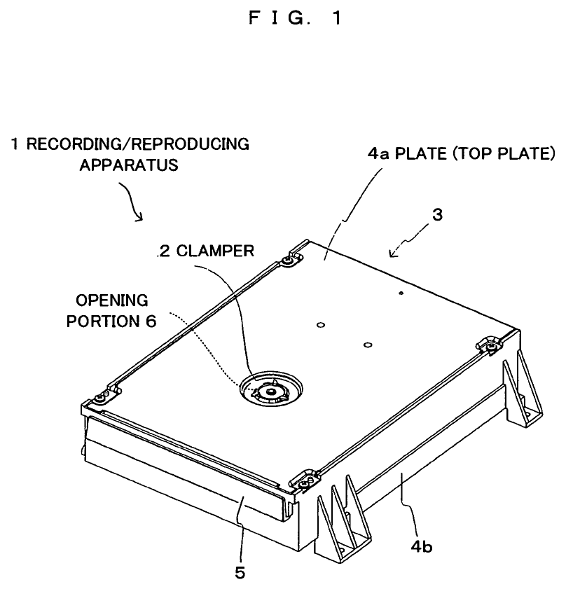

Hereinafter, in order to describe the present invention in greater detail, an embodiment thereof will be described with reference to FIGS. 1 to 9.

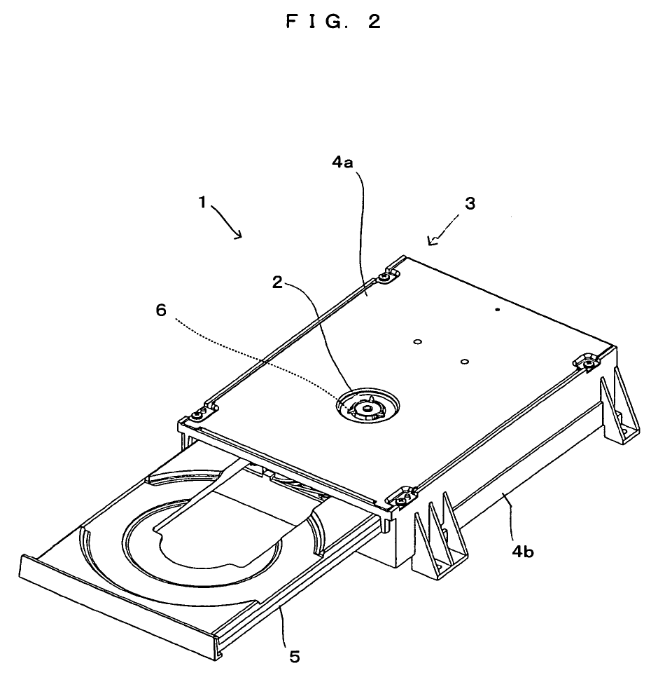

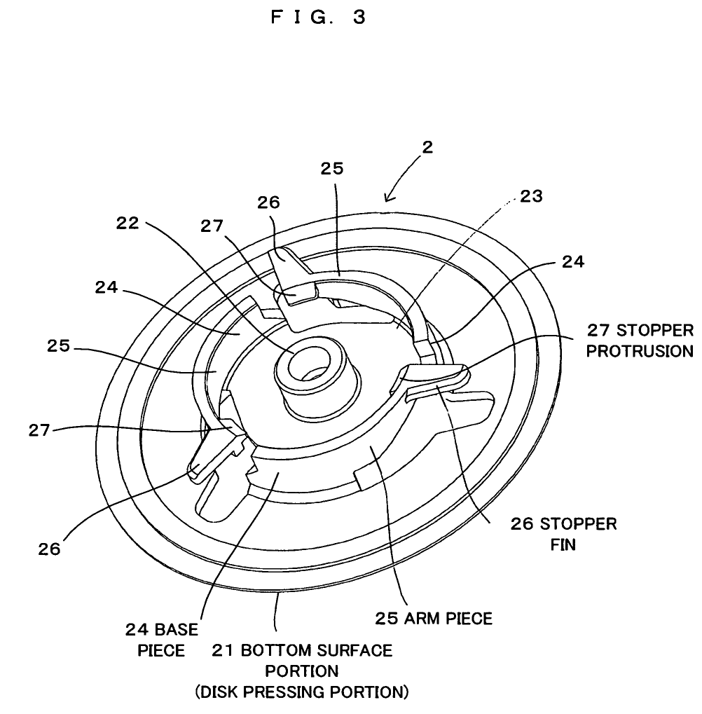

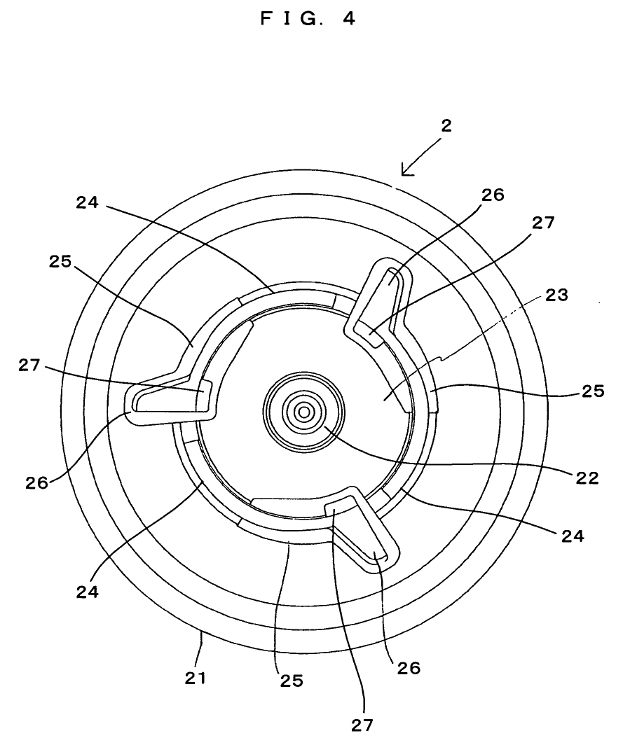

FIG. 1 is a perspective view illustrating an outer appearance shape of a recording/reproducing apparatus of the embodiment when a tray is housed. FIG. 2 is a perspective view illustrating an outer appearance shape of the recording/reproducing apparatus when the tray is unloaded. FIG. 3 is a perspective view illustrating an outer appearance shape of a damper of the embodiment singly. FIG. 4 is a plan view illustrating the damper singly. FIG. 5 is a front view illustrating the damper singly.

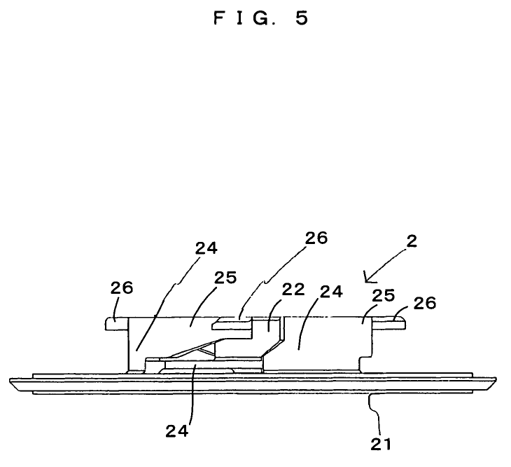

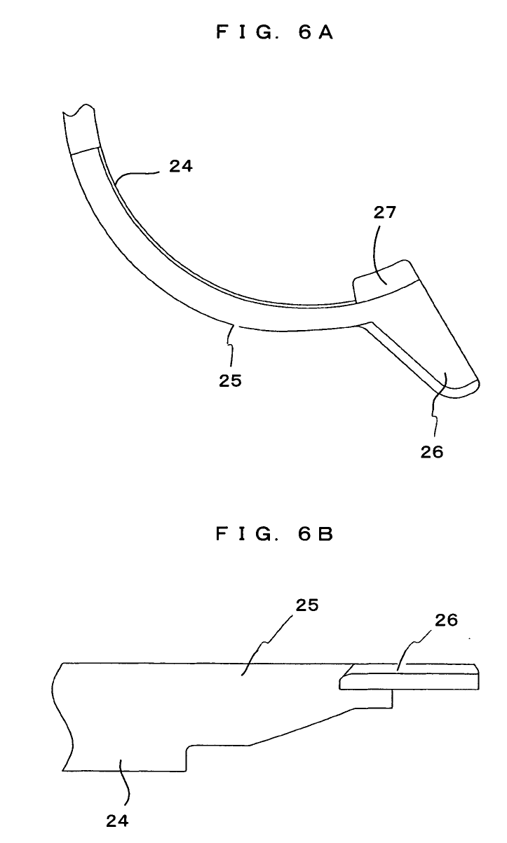

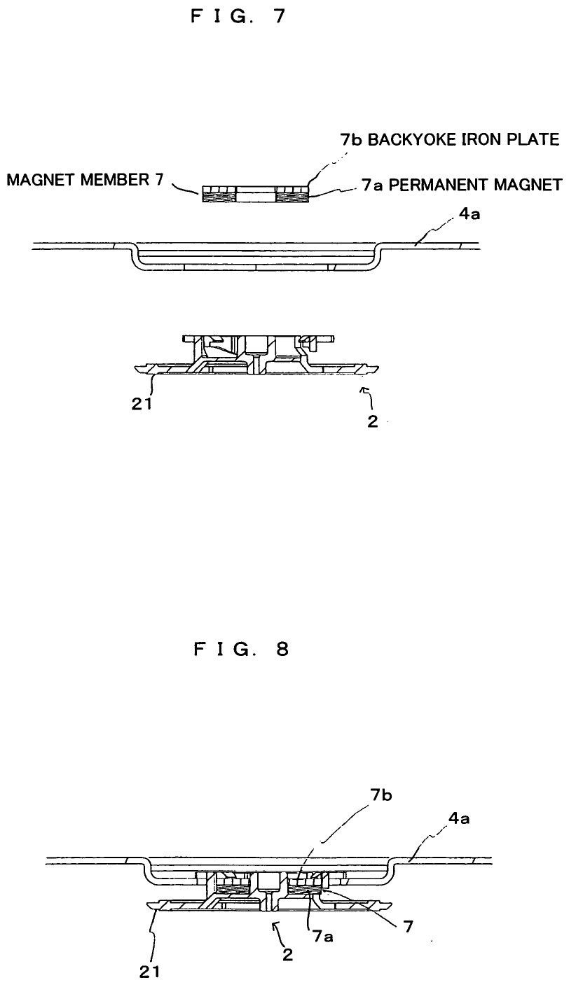

FIGS. 6A and 6B illustrate an arm piece of the damper of the embodiment. FIG. 6A is a partially enlarged plan view illustrating a vicinity of the arm piece. FIG. 6B is a partially enlarged front view illustrating a vicinity of the arm piece. FIG. 7 is a cross-sectional side view illustrating a state of the damper of the embodiment before attachment. FIG. 8 is a cross-sectional side view illustrating a state of the damper of the embodiment after attachment.

As illustrated in FIGS. 1 and 2, the recording/reproducing apparatus 1 of the embodiment has a function of recording or reproducing an optical disk, such as a DVD, a CD or the like. A flat box-shaped outer casing 3 is composed of a main body frame 4b which is open upward and is formed of a synthetic resin, and a plate 4a which is a thin metal top plate covering the upper opening of the main body frame 4b.

The main body frame 4b is formed of a synthetic resin as with well-known recording/reproducing apparatuses. A tray 5 formed of a synthetic resin on which an optical disk can be placed and which can perform linear reciprocation in a front-to-rear direction when the optical disk is loaded and unloaded, is assembled with the main body frame 4b in a manner which allows the tray 5 to be freely conveyed into and out of the main body frame 4b. In the main body frame 4b, a rack loading which is slid in a width direction of the main body frame 4b in association with the linear reciprocation of the tray 5, and a chassis which can swings between an inclined state and a horizontal state in association with the sliding action of the rack loading, are attached. The chassis is provided with a turntable on which the optical disk loaded with the tray 5 is placed and rotated, a pickup unit which emits laser light to a recording surface of the optical disk rotated by the turntable so as to write information onto the optical disk or read information from the optical disk, and the like. A damper 2 is attached to the plate 4a covering the upper opening of the main body frame 4b at a position which allows the damper 2 to face the turntable. The turntable and the damper sandwich and hold the optical disk.

The plate 4a is formed of a metal (steel) which is a magnetic material in view of an improvement in strength of the main body frame 4b, taking measures against unnecessary radiation, and the like. The plate 4a is fitted into an upper portion of the main body frame 4b and four corner portions thereof are fixed with screws.

An opening portion 6 for attaching the damper 2 is provided at a position which is closer to a front of the plate 4a and allows the opening portion 6 to face the turntable. The damper 2 is supported at the position of the opening portion 6 in a manner which allows the damper 2 to freely rotate and freely vertically move.

Next, a shape of the damper 2 which sandwiches and holds an optical disk with the turntable will be described in detail. FIGS. 3 to 5 are respectively a perspective view, a plan view and a front view illustrating the shape of the damper singly. In the case of the embodiment, the damper 2 is integrally formed of a synthetic resin into a single part which includes a magnet member described below.

The damper 2 has a circular dish-shaped bottom surface portion 21 for pressing an optical disk. The bottom surface portion 21 has a diameter slightly larger than that of the opening portion 6 of the plate 4a. A circular peripheral portion (step portion) of the bottom surface portion 21 is higher by one step than a central portion thereof. The central portion is substantially flat.

A cylindrical member 22 is provided on an upper surface of the central portion of the bottom surface portion 21, protruding upward. An annular space around an outer circumference of the cylindrical member 22 provides a housing portion 23 for an annular magnet member 7 illustrated in FIGS. 7 and 8. Note that the magnet member 7 may be a permanent magnet 7a singly, however, in the case of the embodiment, a back yoke iron plate 7b for enhancing a magnetic force is attached to the permanent magnet 7a. In this case, at least, the iron plate 7b has an outer diameter which is substantially equal to an inner diameter of the housing portion 23.

A plurality of thin plate-shaped base pieces 24 are substantially equally spaced and provided on an outer circumference of the housing portion 23 around the magnet member 7. In the embodiment, three base pieces 24 are provided, protruding upward. An arm piece 25 (FIG. 6) is provided, extending from each base piece 24 around the magnet member 7. The arm pieces 25 are bent in the same direction (clockwise or anticlockwise) and have a spring property in a radial direction of rotation.

Each arm piece 25 has a shape that a gap between the arm piece 25 and the bottom surface portion 21 increases from a portion thereof closer to the base piece 24 toward a tip portion thereof. The vertical movement stroke of the damper 2 in association with the loading/unloading action of the tray 5, which allows an optical disk to be placed, is performed by a helical movement action in a direction from the base piece 24 to the tip portion or in the opposite direction.

As illustrated in FIGS. 6A and 6B, at least, a stopper fin 26 substantially horizontally protruding in a radially outward direction of the bottom surface portion 21 is provided at the tip portion of each arm piece 25. A stopper protrusion 27 is provided at the whole (the embodiment) or a part of the tip portion provided with the stopper fin 26. The stopper protrusion 27 protrudes in a radially inward direction of the bottom surface portion 21 with a lower surface of the stopper protrusion 27 contacting an upper surface of the magnet member 7.

Note that, in the embodiment, each stopper fin 26 is formed by cutting a portion of the housing portion 23. An upper surface of each stopper fin 26 is inclined downward so that the damper 2 can be simply loosely fitted into the opening portion 6 of the plate 4a. Also, an upper surface of each stopper protrusion 27 is inclined downward so that the magnet member 7 (FIG. 7) can be easily fitted from the top.

When the damper 2 is attached to the plate 4a, the housing portion 23 of the damper 2 is initially inserted into the opening portion 6 provided in the plate 4a from below the plate 4a. In this case, due to the inclined upper surface of each stopper fin 26, each arm piece 25 of the damper 2 is bent toward the housing portion 23 against the spring property, so that the damper 2 is easily inserted through the opening portion 6. When the housing portion 23 is passed through the opening portion 6 and reaches an upper surface of the plate 4a, each bent (deformed) arm piece 25 is expanded toward the outer circumference side due to a restoring force which tries to restore the original state, so that a lower surface of each stopper fin 26 contacts the upper surface of the plate 4a, whereby the damper 2 is engaged with the opening portion 6 of the plate 4a.

Next, the magnet member 7 is fitted and attached to the housing portion 23 of the damper 2 of the plate 4a from the top. In this case, since the upper surface of each stopper protrusion 27 is inclined, the magnet member 7 can be easily fitted. Also, the fitted magnet member 7 controls the deformation of each bent arm piece 25.

In this manner, the damper 2 is loosely fitted into the opening portion 6 of the plate 4a and is attached to the plate 4a, suspending from the plate 4a as illustrated in FIG. 8. In this state, the bottom surface portion 21 having a diameter larger than that of the opening portion 6 is located below a lower surface of the plate 4a and above the turntable. Above the plate 4a, the stopper fin 26 at the tip of each arm piece 25 formed by cutting a part of the housing portion 23 is engaged with the plate 4a, so that the damper 2 can be vertically moved (stroke) between the bottom surface portion 21 and the stopper fin 26.

As a result, the stroke (vertical movement) of the clamper 2 in association with the loading/unloading action of the tray 5, which allows an optical disk to be placed, is secured by a so-called helical movement action, thereby making it possible to reduce the thickness as compared to the conventional damper structure, and also reduce the thickness of the recording/reproducing apparatus 1 comprising the damper 2. In addition, the substantially horizontal stopper fin 26 is used to secure a sufficient degree of hooking with respect to the plate 4a so that the damper 2 can be reliably engaged with the plate 4a.

In addition, since only a resin portion of the damper 2 contacts the plate 4a in the helical movement action, there is an effect of suppressing strike sound between the upper surface of the plate 4a and each stopper fin, strike sound between the lower surface of the plate 4a and the bottom surface portion 21, and the like in the following situations: the chassis is tilted in a direction which raises the turntable to approach the damper 2 including the magnet member 7, so that a magnetic force which attracts the damper 2 in a pull-down direction is applied, and the bottom surface portion 21 of the damper 2 presses the upper surface of the optical disk placed on the turntable (i.e., the optical disk is sandwiched and held); the chassis is tilted in a direction which lowers the turntable to go away from the damper 2, so that a magnetic force generated between the magnet member 7 included in the damper 2 and the plate 4a pulls up the camper 2, and therefore, the optical disk is not sandwiched or held; and the reverse operation is performed. Thereby, discomfort strike sound due to the vertical movement of the damper 2 is reduced, thereby making it possible to improve the low noise property.

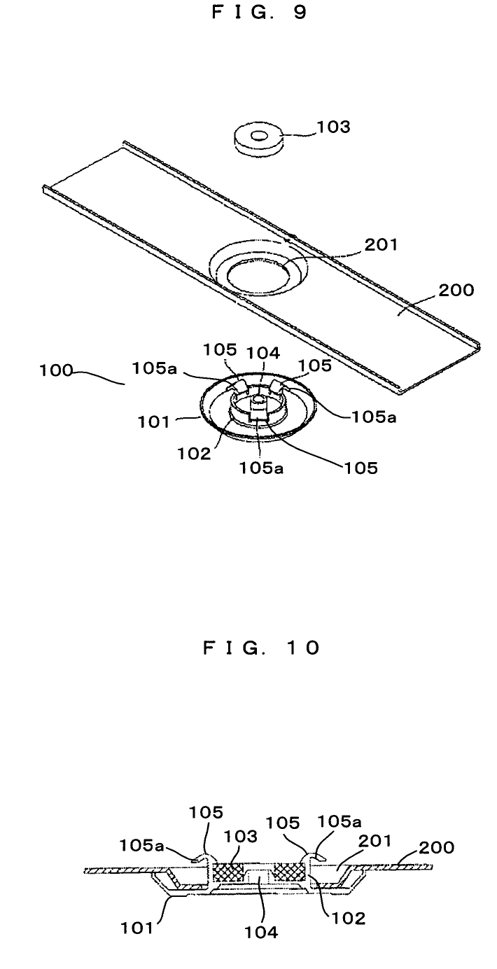

The present invention is not limited to the above-described embodiment. Other changes can be made without departing the spirit and scope of the present invention. For example, the number of arm pieces 25 or the like is not limited to three indicated in the embodiment and may be arbitrarily selected. Also, instead of the plate 4a, the damper 2 of the embodiment may be attached to various support plates, such as a horizontal magnetic material and the like (the support member 200 of the conventional example of FIGS. 9 and 10).

Further, settings of dimensions and shapes of parts (the damper 2, etc.) may be changed, depending on design conditions or the like.

The magnet member 7 in the housing portion 23 may be only the permanent magnet 7a to further reduce the number of parts, thereby simplifying management of parts in a manufacturing factory or the like, simplifying the assembly process of the damper 2, and the like. To make the magnet member 7 more inexpensive to further reduce the cost of a recording/reproducing apparatus and the like, the thickness dimension of the permanent magnet 7a may be reduced, and the permanent magnet 7a may be attached to the housing portion 23 while the permanent magnet 7a is stacked with the backyoke iron plate 7b having the same diameter.

The present invention can be applied to dampers of recording/reproducing apparatuses having various outer appearance shapes and sizes, thereby reducing the thickness of the recording/reproducing apparatuses, and reducing the thickness of electronic apparatuses comprising the recording/reproducing apparatuses including the clampers.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

1. A damper for a recording/reproducing apparatus, said damper being fitted in an attachment opening portion provided in a horizontal support plate in a manner which allows said damper to freely rotate and freely vertically move, said damper comprising:
a circular dish-shaped bottom surface portion for pressing a disk-shaped storage medium;
an annular magnet member provided at a central portion of an upper surface of said bottom surface portion;
a plurality of base pieces spaced apart from each other and disposed around said magnet member;
elastic arm pieces bent and extending in the same direction from said respective base pieces and provided at a distance from said bottom surface portion; and
substantially horizontal stopper fins provided at tip portions of said respective arm pieces and protruding in a radially outward direction of said bottom surface portion.

2. A damper for a recording/reproducing apparatus, said damper being fitted in an attachment opening portion provided in a horizontal support plate in a manner which allows said damper to freely rotate and freely vertically move, said damper comprising:
a circular dish-shaped bottom surface portion for pressing a disk-shaped storage medium;
an annular magnet member provided at a central portion of an upper surface of said bottom surface portion;
a plurality of base pieces spaced apart from each other and disposed around said magnet member;
elastic arm pieces bent and extending in the same direction from said respective base pieces and provided at a distance from said bottom surface portion; and
substantially horizontal stopper fins provided at tip portions of said respective arm pieces and protruding in a radially outward direction of said bottom surface portion,
wherein said bottom surface portion, said base pieces, said arm pieces and said stopper fins constituting said damper are integrally formed.

3. A damper for a recording/reproducing apparatus, said damper being fitted in an attachment opening portion provided in a horizontal support plate in a manner which allows said damper to freely rotate and freely vertically move, said damper comprising:
a circular dish-shaped bottom surface portion for pressing a disk-shaped storage medium;
an annular magnet member provided at a central portion of an upper surface of said bottom surface portion;
a plurality of base pieces spaced apart from each other and disposed around said magnet member;
elastic arm pieces bent and extending in the same direction from said respective base pieces and provided at a distance from said bottom surface portion; and
substantially horizontal stopper fins provided at tip portions of said respective arm pieces and protruding in a radially outward direction of said bottom surface portion,
wherein an upper surface of said stopper fin is inclined downward.

4. A damper for a recording/reproducing apparatus, said damper being fitted in an attachment opening portion provided in a horizontal support plate in a manner which allows said damper to freely rotate and freely vertically move, said damper comprising:
a circular dish-shaped bottom surface portion for pressing a disk-shaped storage medium;
an annular magnet member provided at a central portion of an upper surface of said bottom surface portion;
a plurality of base pieces spaced apart from each other and disposed around said magnet member;
elastic arm pieces bent and extending in the same direction from said respective base pieces and provided at a distance from said bottom surface portion; and
substantially horizontal stopper fins provided at tip portions of said respective arm pieces and protruding in a radially outward direction of said bottom surface portion,
wherein said bottom surface portion, said base pieces, said arm pieces and said stopper fins constituting said damper are integrally formed, and
an upper surface of said stopper fin is inclined downward.

5. The damper for the recording/reproducing apparatus according to any one of claims 1 to 4, wherein a stopper protrusion protruding in a radially inward direction of said bottom surface portion is provided at least at a portion of said arm pieces, and
a lower surface of said stopper protrusion contacts an upper surface of said magnet member provided at the central portion of the upper surface of said bottom surface portion.

6. The damper for the recording/reproducing apparatus according to claim 5, wherein an upper surface of said stopper protrusion is inclined downward.

7. A recording/reproducing apparatus comprising:
a horizontal support plate made of a metal and having an attachment opening portion, wherein said horizontal support plate is provided on an upper surface of an outer casing;
the damper according to any one of claims 1 to 4, wherein said damper is made of a resin and said damper is fitted into said attachment opening portion of said support plate in a manner which allows said damper to freely rotate and freely vertically move;
a magnet member provided in said clamper;
a turntable including a magnetic material for holding up a storage medium inserted into the outer casing from a position where said magnetic material faces said clamper so that said storage medium can be rotated; and
a pickup unit for irradiating a recording surface of said storage medium with laser light to read or write information,
wherein said turntable can be moved in a height direction,
wherein said turntable is at a height position, said turntable and the clamper at an opposed position sandwich and hold said storage medium due to a magnetic force, and when said turntable is at a low position, a magnetic force acts between said clamper at the opposed position and said support plate to pull up said clamper due to an attraction force.
